(19) United States
(12) Patent Application Publication
(10) Pub. No.: US 2021/0285655 A1
(43) Pub. Date: Sep. 16, 2021

(54) ELECTRIC RANGE

(71) Applicant: LG ELECTRONICS INC., Seoul (KR)

(72) Inventors: Il Young PARK, Seoul (KR); Jaeho LEE, Seoul (KR); Seunghak KIM, Seoul (KR)

(73) Assignee: LG ELECTRONICS INC.

(21) Appl. No.: 17/199,632

(22) Filed: Mar. 12, 2021

(30) Foreign Application Priority Data
Mar. 12, 2020 (KR) 10-2020-0030997

(51) Int. Cl. F24C 15/08; F24C 7/06

(52) U.S. Cl. CPC F24C 15/08; F24C 7/067

(57) ABSTRACT

An electric range is provided in which a lower surface of a base plate on which a working coil is disposed may be supported along a widthwise direction of the base plate, thereby preventing bending of the base plate and absorbing an external impact applied to the base plate. Additionally, in the electric range, a gap between a working coil on a base plate and an object to be heated on/over the working coil may be maintained.

### CROSS-REFERENCE TO RELATED APPLICATION(S)

This application claims priority under 35 U.S.C. § 119 to Korean Application No. 10-2020-0030997 filed on Mar. 12, 2020, whose entire disclosure(s) is/are hereby incorporated by reference.

### BACKGROUND

### 1. Field

An electric range is disclosed herein.

### 2. Background

Various types of cooking appliances are used to heat food or other items (hereinafter, collectively “food”) at homes or restaurants. The cooking appliances include gas ranges using gas and electric ranges using electricity.

The electric ranges are classified as resistance heating-type electric ranges and induction heating-type electric ranges. In a resistance heating method, electric current is supplied to a metallic resistance wire or a non-metallic heat generation element, such as silicon carbide to generate heat, and the generated heat is radiated or conducted to heat an object to be heated, for example, a cooking vessel, such as a pot, or a frying pan, for example. In an induction heating method, high-frequency power is supplied to a coil to generate a magnetic field around the coil, and eddy current produced in the generated magnetic field is used to heat an object to be heated made of a metallic material.

When electric current is supplied to a working coil or a heating coil, heat is generated while an object to be heated is inductively heated. The object to be heated is heated by the generated heat.

A working coil of an electric range of the related art, configured as described above, is disposed at an upper end of a base plate made of aluminum. The base plate is disposed at an upper end of a case forming a space in which a substrate and electronic components are disposed.

The working coil is made of a metallic material and has a predetermined weight. In the related art, elastic rods elastically supporting edges of the base plate are disposed in the case to support the base plate. When the working coil is disposed at an upper end of a center of the base plate, the center of the base plate bends downward. Additionally, when each of the elastic rods has a different elastic force, the base plate tilts to one side without ensuring a balance. Thus, in the related art, a constant gap between an object to be heated, mounted onto a cover disposed on the base plate, and a working coil cannot be ensured.

### BRIEF DESCRIPTION OF THE DRAWINGS

Embodiments will be described in detail with reference to the following drawings in which like reference numerals refer to like elements, and wherein:

FIG. 1 is a perspective view of an electric range according to an embodiment;

FIGS. 2 to 5 are perspective views of the electric range in FIG. 1 without some components;

FIG. 6 is a perspective view of an electric range having supporters according to an embodiment;

FIG. 7 is a perspective view of a bracket according to an embodiment;

FIG. 8 is another perspective view of the bracket according to an embodiment;

FIG. 9 is a perspective view of an elastic member according to an embodiment;

FIG. 10 is a perspective view of a supporter according to an embodiment elastically supporting a lower portion of a base plate; and

FIG. 11 is a view showing an example in which a position of an elastic member according to an embodiment may be changed at an upper end of a bracket.

### DETAILED DESCRIPTION

Embodiments are described hereinafter with reference to the accompanying drawings such that one having ordinary skill in the art to which the embodiments pertain may easily implement the technical idea. In the disclosure, description of known technologies in relation to the disclosure is omitted if it is deemed to make the gist unnecessarily vague. In the drawings, the same or like reference numerals denote the same or like components.

The terms “first”, “second” and the like are used herein only to distinguish one component from another component. Thus, the components should not be limited by the terms. Certainly, a first component can be a second component unless stated to the contrary.

When one component is described as being “in an upper portion (or a lower portion)” of another component, or “on (or under)” another component, one component can be placed on the upper surface (or under the lower surface) of another component, and an additional component may be interposed between another component and one component on (or under) another component.

When one component is described as being “connected”, “coupled”, or “connected” to another component, one component can be directly connected, coupled or connected to another component; however, it is also to be understood that an additional component can be “interposed” between the two components, or the two components can be “connected”, “coupled”, or “connected” through an additional component.

Hereinafter, each component may be provided as a single one or a plurality of ones, unless explicitly stated to the contrary.

The singular forms “a”, “an” and “the” are intended to include the plural forms as well, unless explicitly indicated otherwise. It should be further understood that the terms “comprise” or “have,” set forth herein, are not interpreted as necessarily including all the stated components or steps but can be interpreted as including some of the stated components or steps or can be interpreted as further including additional components or steps.

Hereinafter, the terms “A and/or B” as used herein can denote A, B or A and B, and the terms “C to D” can denote C or greater and D or less, unless stated to the contrary.

Hereinafter, an electric range is described with reference to several embodiments. The electric range disclosed herein may include an electric resistance-type electric range and an induction heating-type electric range, for example, an induction heating device. For convenience, an induction heating device, provided with a working coil as a heating unit, is described as an example during description of the embodiments. However, embodiments are not limited to those set forth herein.

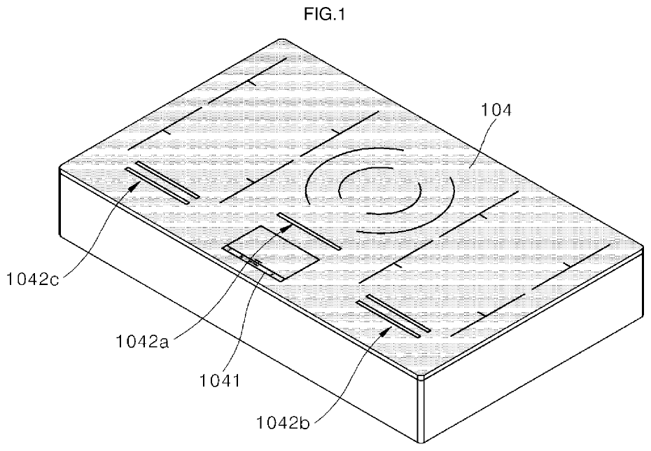

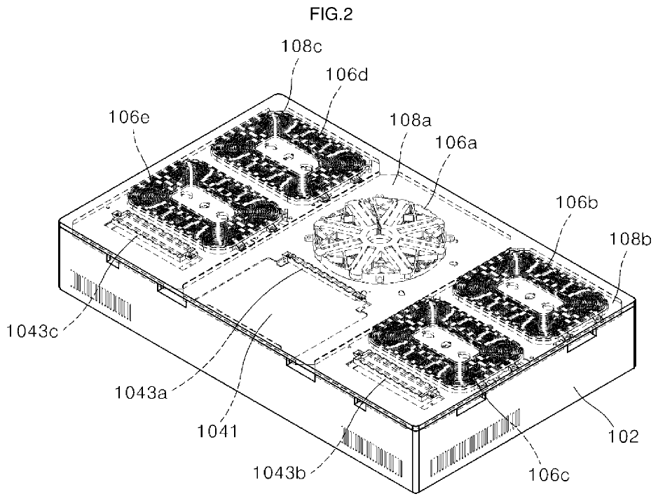

FIG. 1 is a perspective view of an electric range 100 according to an embodiment. FIGS. 2 to 5 are perspective views of the electric range 100 in FIG. 1 without some components.

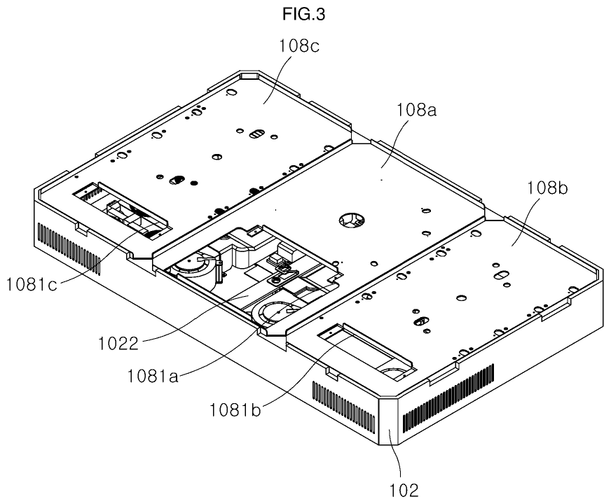

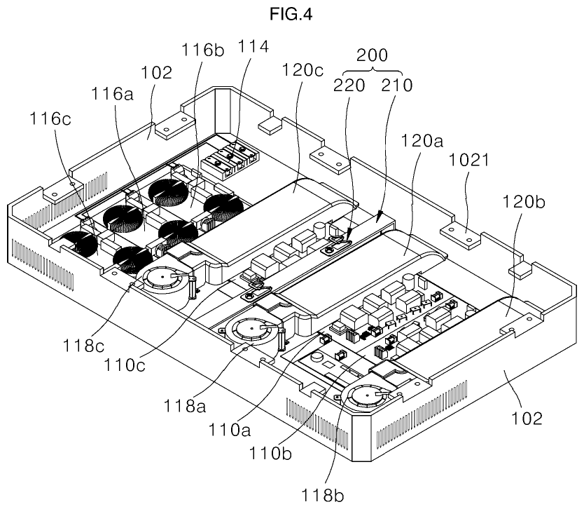

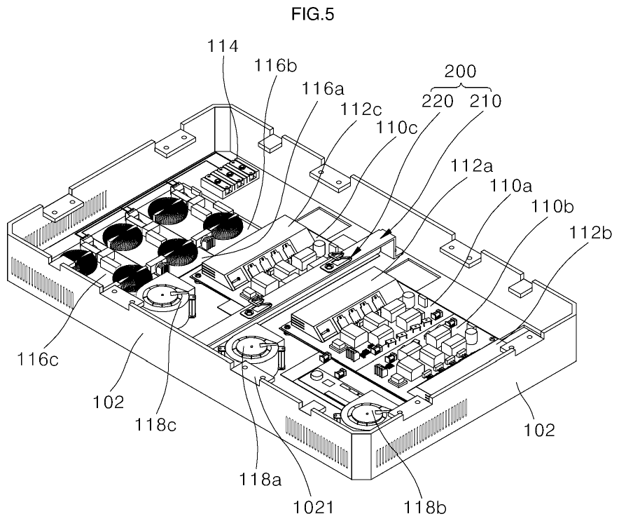

More specifically, FIG. 2 is a view showing the electric range 100 in FIG. 1 without cover plate 104, FIG. 3 is a view showing the electric range 100 in FIG. 1 without cover plate 104 and one or more working coil 106a, 106b, 106c, 106d, 106e, FIG. 4 is a view showing the electric range 100 in FIG. 1 without cover plate 104, one or more working coil 106a, 106b, 106c, 106d, 106e, and one or more base plate 108a, 108b, 108c, and FIG. 5 is a view showing the electric range 100 in FIG. 1 without cover plate 104, one or more working coil 106a, 106b, 106c, 106d, 106e, one or more base plate 108a, 108b, 108c, and one or more air guide 120a, 120b, 120c.

Referring to FIGS. 1 to 5, the electric range 100 according to an embodiment may include a case 102, the cover plate 104, the one or more working coil 106a, 106b, 106c, 106d, 106e, the one or more base plate 108a, 108b, 108c, one or more drive circuit 110a, 110b, 110c, one or more heat sink 112a, 112b, 112c, a power feeder 114, one or more filter circuit 116a, 116b, 116c, one or more air blowing fan 118a, 118b, 118c, and one or more air guide 120a, 120b, 120c. The case 102 may protect components in the electric range 100. For example, the case 102 may be made of aluminum or any other suited metal; however, embodiments are not limited thereto. The case 102 may be thermally insulated to prevent heat, generated by the one or more working coil 106a, 106b, 106c, 106d, 106e, from leaking outward. The case 102 is formed to have a predetermined height. The case 102 has two short side portions and two long side portion being connected or integrally formed to form a frame which surrounds the inner space. The case 102 is open at its upper portion and may be closed at the bottom surface 102b with a bottom plate.

The cover plate 104 may be coupled to an upper end of the case 102 to shield an inside of the case 102, and an object to be heated (not illustrated, an object to be heated by the one or more working coils 106a, 106b, 106c, 106d, 106e) may be placed on an upper surface of the cover plate 104.

An object to be heated, such as a cooking vessel, may be placed on the upper surface of the cover plate 104, and heat generated by the working coil 420 may be delivered to the object to be heated through the upper surface of the cover plate 104. The cover plate 104 may be made of glass; however, embodiments are not limited thereto.

An input interface 1041 configured to receive an input from a user may be disposed on the upper surface of the cover plate 104. The input interface 1041 may be recessed into the upper surface of the cover plate 104 in a flat manner and may display a specific image. The input interface 1041 may receive a touch input from the user, and the electric range 100 may be driven based on the received touch input.

More specifically, the input interface 1041 may be a module for controlling the operation the electric range, in particular by inputting a heating intensity and/or a heating period, for example, desired by the user, and may be implemented as a physical button or a touch panel, for example. Additionally, the input interface 1041 may display a drive state of the electric range 100. For example, the input interface 1041 may include a liquid crystal display (TFT LCD); and LED or a OLED; however, embodiments are not limited thereto.

One or more light display area 1042a, 1042b, 1042c may be formed on the upper surface of the cover plate 104. One or more light source unit (lighting unit) 1043a, 1043b, 1043c may be disposed below/under the cover plate 104, and light emitted from the one or more light source unit 1043a, 1043b, 1043c may be delivered to the user through the one or more light display area 1042a, 1042b, 1042c.

The working coil 106a, 106b, 106c, 106d, 106e may be a heating unit that heats an object to the heated, and may be disposed in the case 102. The working coil 106a, 106b, 106c, 106d, 106e may include a wire wound multiple times in a ring shape, and may generate an alternating current (AC) magnetic field. Additionally, a mica sheet and a ferrite core may be consecutively disposed on a lower side of the working coil 106a, 106b, 106c, 106d, 106e.

The ferrite core may be fixed to the mica sheet through a sealant, and may diffuse the AC magnetic field generated by the working coil 106a, 106b, 106c, 106d, 106e. The mica sheet may be fixed to the working coil 106a, 106b, 106c, 106d, 106e and the ferrite core through the sealant, and may prevent direct delivery of the heat, generated by the working coil 106a, 106b, 106c, 106d, 106e, to the ferrite core.

A plurality of working coils 106a, 106b, 106c, 106d, 106e may be provided. The plurality of working coils 106a, 106b, 106c, 106d, 106e may include first working coil 106a disposed at a central portion of the case 102, second working coil 106b and third working coil 106c disposed on a right (first) side of the first working coil 106a, and a fourth working coil 106d and a fifth working coil 106e disposed on a left (second) side of the first working coil 106a. The second working coil 106b and the third working coil 106c may be disposed on the right side of the first working coil 106a in a frontward-rearward direction, and the fourth working coil 106d and the fifth working coil 106e may be disposed on the left side of the first working coil 106a in the frontward-rearward direction.

For example, the first working coil 106a may be a high-output dual heating coil, and the second working coil 106b, the third working coil 106c, the fourth working coil 106d and the fifth working coil 106e may be a single heating coil. The first working coil 106a as a dual heating coil may be heavy and may have a maximum output of 7000 kW.

The electric range 100 according to an embodiment may perform the function of wireless power transmission based on configurations and features described above.

Technologies for wirelessly supplying power have been developed and have been used for a wide range of electronic devices. A battery of an electronic device, to which the wireless power transmitting technology is applied, can be charged only by being placed on a charge pad without connecting to an additional charge connector. Accordingly, the electronic device, to which the wireless power transmitting technology is applied, requires no cord or no charger, thereby ensuring improved mobility and a reduced size and weight.

The wireless power transmitting technology can be broadly classified as an electromagnetic induction technology using a coil, a resonance technology using resonance, and a radio emission technology for converting electric energy into microwaves and delivering the microwaves, for example. In the electromagnetic induction technology, power is transmitted using electromagnetic induction between a primary coil, that is, a working coil, included in an apparatus for wirelessly transmitting power and a secondary coil included in an apparatus for wirelessly receiving power.

The theory of the induction heating technology of the electric range 100 is substantially the same as that of the electromagnetic induction-based wireless power transmission technology, in that an object to be heated is heated using electromagnetic induction. Accordingly, the electric range 100 according to an embodiment may perform the function of wireless power transmission as well as the function of induction heating.

The one or more base plate 108a, 108b, 108c may be disposed at a middle of the case 102. So the one or more base plates may separate the inner space of the case into a lower portion and an upper portion. The upper portion is for accommodating the working coils. The lower portions is provided for accommodating the electronic components.

The plurality of working coils 106a, 106b, 106c, 106d, 106e may be disposed on the one or more base plates 108a, 108b, 108c. The one or more base plate 108a, 108b, 108c may support the plurality of working coils 106a, 106b, 106c, 106d, 106e, which are heavy, and may help the plurality of working coils 106a, 106b, 106c, 106d, 106e to be mounted. The input interface 1041 and the one or more light source unit 1043a, 1043b, 1043c may be further disposed at the upper portion of the one or more base plate 108a, 108b, 108c.

According to one embodiment, a plurality of base plates 108a, 108b, 108c may be provided; however, embodiments are not limited thereto. Alternatively, a single base plate may be disposed in the case 102.

The plurality of base plates 108a, 108b, 108c may include first base plate 108a, second base plate 108b, and third base plate 108c. The first base plate 108a, the second base plate 108b, and the third base plate 108c may be disposed at the middle of the case 102 side by side. Middle end means a position lower than the upper edge of the case and higher as the bottom surface of the case.

The first base plate 108a may be disposed at a central portion of the middle of the case 102. The first working coil 106a may be disposed on the first base plate 108a.

The input interface 1041, and first light source unit 1043a corresponding to the first working coil 106a may be disposed on the first base plate 108a. On/In the upper portion of the first base plate 108a, the input interface 1041 may be disposed on a lower side of the first light source unit 1043a, and the first light source unit 1043a may be disposed on a lower side of the input interface 1041. The first base plate 108a may have a through hole 1081a for installing the input interface 1041 and the first light source unit 1043a.

The second base plate 108b may be disposed on a right (first) side of the first base plate 108a at the middle of the case 102. The second working coil 106b and the third working coil 106c may be disposed on/in an upper portion of the second base plate 108b.

A second light source unit 1043b corresponding to the second working coil 106b and the third working coil 106c may be further disposed on/in the upper portion of the second base plate 108b. On/In the upper portion of the second base plate 108b, the second working coil 106b, the third working coil 106c, and the second light source unit 1043b may be consecutively disposed. The second base plate 108b may have a through hole 1081b for installing the second light source unit 1043b.

The third base plate 108c may be disposed on a left (second) side of the first base plate 108a at the middle of the case 102. The fourth working coil 106d and the fifth working coil 106e may be disposed on/in an upper portion of the third base plate 108c.

A third light source unit 1043c corresponding to the fourth working coil 106d and the fifth working coil 106e may be further disposed on/in the upper portion of the third base plate 108c. On/In the upper portion of the third base plate 108c, the fourth working coil 106d, the fifth working coil 106e, and the third light source unit 1043c may be consecutively disposed. The third base plate 108c may have a through hole 1081c for installing the third light source unit 1043c.

The case 102 may have a plurality of mounting portions 1021 to mount the plurality of base plates 108a, 108b, 108c in portions of an outer circumferential surface of the case 102. The mounting portions 1021 are bent inside the inner space of the case. That is, edges of the plurality of base plates 108a, 108b, 108c may be mounted onto tops of the plurality of mounting portions 1021. Accordingly, the plurality of base plates 108a, 108b, 108c may be disposed at the middle of the case 102.

A bracket 210 may be disposed at a central portion of a lower end of the case 102. The bracket 210 may be disposed at a central portion of a lower side of the first base plate 108a, and may prevent bending, that is, sagging of the first base plate 108a, caused by a weight of the first base plate 108a. The weight of the first base plate 108a may include a weight of the first working coil 106a on/in the upper portion of the first base plate 108a.

At least one elastic member 220 may be disposed on the bracket 210. For example, the elastic member 220 may be a leaf spring. An upper end of at least one elastic member 220 may contact a lower surface of the first base plate 108a, and may prevent sagging of the first base plate 108a. In the above configuration, the central portion of the first base plate 108a on which the first working coil 106a is disposed may sag further than any other area, due to the weight of the first working coil 106a. So, the bracket 210 and at least one elastic member 220 may form a supporter 200.

To solve the problem, the elastic member 220 disposed at the upper end of the bracket 210 according to the disclosure may be disposed to support the central portion of the lower surface of the first base plate 108a.

Alternatively, the elastic member 220 disposed at the upper end of the bracket 210 may be disposed to support a portion under a central portion of the first working coil 106a, while a portion under the area where the first working coil 106a is disposed.

Additionally, among the working coils 106a, 106b, 106c, 106d, 106e, the weight of the first working coil 106a formed into a dual-type working coil is heavier than any other working coil (the second, third, fourth and fifth working coils 106b, 106c, 106d, 106e). Accordingly, the elastic member 220 at the upper end of the bracket 210 may support the lower surface of the first base plate 108a on a lower side of the first working coil 106a.

The one or more drive circuit 110a, 110b, 110c may control driving of the plurality of working coils 106a, 106b, 106c, 106d, 106e, which are heating units, and may further control driving of components, such as the input interface 1041, for example, of the electric range 100.

The one or more drive circuit 110a, 110b, 110c may include various components in relation to the driving of the working coils 106a, 106b, 106c, 106d, 106e. The components may include a power supply configured to supply AC power, a rectifier configured to rectify AC power of the power supply into direct current (DC) power, an inverter configured to convert DC power, rectified by the rectifier, into resonance current as a result of a switching operation and supply the resonance current to the working coil 106, a microcomputer, for example, a micom configured to control the inverter and components in relation to driving of the inverter, and a relay or a semiconductor switch configured to turn on or turn off the working coils 106a, 106b, 106c, 106d, 106e, for example.

The one or more drive circuit 110a, 110b, 110c may include first drive circuit 110a, second drive circuit 110b, and third drive circuit 110c. The first drive circuit 110a may be disposed on a right (first) side of the lower end of the case 102 with respect to the bracket 210 and may control driving of the first working coil 106a. The second drive circuit 110b may be disposed on a right (first) side of the first drive circuit 110a and may control driving of the second working coil 106b and the third working coil 106c. The third drive circuit 110c may be disposed on a left (second) side of the lower end of the case 102 with respect to the bracket 210 and may control driving of the fourth working coil 106d and the fifth working coil 106e.

The one or more heat sink 112a, 112b, 112c may be disposed over a portion of the drive circuit 110a, 110b, 110c and may prevent an increase in temperature of components disposed in or at a portion of the drive circuits 110a, 110b, 110c. The one or more heat sink 112a, 112b, 112c may include first heat sink 112a, second heat sink 112b, and third heat sink 112c. The first heat sink 112a may prevent an increase in temperature of components installed in a portion of the first drive circuit 110a, the second heat sink 112b may prevent an increase in temperature of components installed in a portion of the second drive circuit 110b, and the third heat sink 112c may prevent an increase in temperature of components installed in a portion of the third drive circuit 110c.

The power feeder 114 may supply power from an external power source to the electric range 100. The power feeder 114 may be implemented as a terminal block, for example.

The power feeder 114 may be disposed at any one of edges of the lower end of the case 102. For example, the power feeder 114 may be disposed at an upper end of the left side of the lower end of the case 102.

The one or more filter circuit 116a, 116b, 116c may be disposed at any one of the edges of the lower end of the case 102, and may reduce noise made by the plurality of working coils 106a, 106b, 106c, 106d, 106e. The one or more filter circuit 116a, 116b, 116c may include first filter circuit 116a, second filter circuit 116b, and third filter circuit 116c.

The first filter circuit 116a may reduce noise made by the first working coil 106a. The second filter circuit 116b may reduce noise made by the second working coil 106b and the third working coil 106c. The third filter circuit 116c may reduce noise made by the fourth working coil 106d and the fifth working coil 106e.

The one or more air blowing fan 118a, 118b, 118c may reduce a temperature inside of the case 102. Accordingly, the one or more air blowing fan 118a, 118b, 118c may lower a temperature of various components installed in or on the drive circuits 110a, 110b, 110c.

The one or more air blowing fan 118a, 118b, 118c may include first air blowing fan 118a, second air blowing fan 118b, and third air blowing fan 118c. The first air blowing fan 118a may cool various components installed in or on the first drive circuit 110a and may further cool the light source unit 1043 corresponding to the first working coil 106a. In particular, the first air blowing fan 118a may deliver air (wind) for cooling to the first heat sink 112a over the first drive circuit 110a.

The second air blowing fan 118b may cool various components installed in or on the second drive circuit 110b and may further cool the light source unit 1043 corresponding to the second working coil 106b and the third working coil 106c. In particular, the second air blowing fan 118b may deliver air for cooling to the second heat sink 112b over the second drive circuit 110b.

The third air blowing fan 118c may cool various components installed in or on the third drive circuit 110c and may further cool the light source unit 1043 corresponding to the fourth working coil 106d and the fifth working coil 106e. In particular, the third air blowing fan 118c may deliver air for cooling to the third heat sink 112c over the third drive circuit 110c.

The air blowing fan 118a, 118b, 118c may not be provided with a structure for preventing a foreign substance from contacting the air blowing fan 118a, 118b, 118c. The air guide 120a, 120b, 120c may guide air (wind) generated by the air blowing fan 118a, 118b, 118c.

The air guide 120a, 120b, 120c may include first air guide 120a, second air guide 120b and a third guide 120c. The first air guide 120a may encircle the first heat sink 112a installed over a portion of the first drive circuit 110a and may guide (deliver) air, output from the first air blowing fan 118a, to the first heat sink 112a. The second air guide 120b may encircle the second heat sink 112b installed over a portion of the second drive circuit 110b and may guide air, output from the second air blowing fan 118b, to the second heat sink 112b. The third air guide 120c may encircle the third heat sink 112c installed over a portion of the third drive circuit 110c and may guide air, output from the third air blowing fan 118c, to the third heat sink 112c.

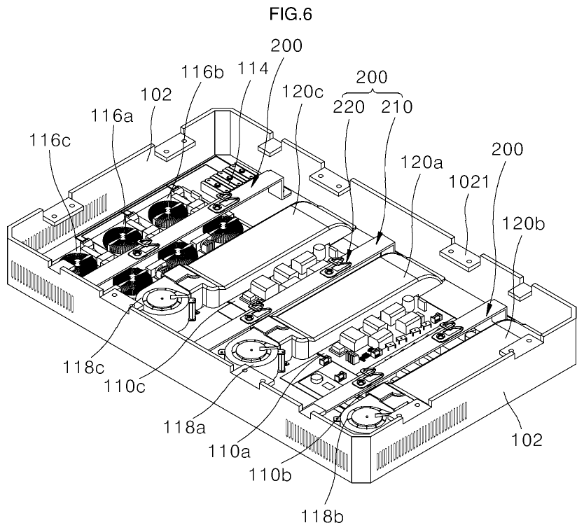

FIG. 6 is a perspective view showing an electric range having supporters according to an embodiment. Referring to FIGS. 1 to 5, the electric range 100 according to an embodiment may include case 102, one or more base plate 108a, 108b, 108c (see FIG. 3), one or more working coil 106a, 106b, 106c, 106d, 106e, and supporter 200, as described above.

An upper portion of the case 102 may be open. The case 102 may have a square shape and include four walls 102a and one bottom surface 102b.

Referring to FIG. 3, the base plate 108a, 108b, 108c may include first, second and third base plates 108a, 108b, 108c. The working coil 106a, 106b, 106c, 106d, 106e may include first, second, third, fourth, and fifth working coils 106a, 106b, 106c, 106d, 106e.

The first working coil 106a may be disposed at an upper end of the first base plate 108a. The second and third working coils 106b, 106c may be spaced a predetermined distance apart at an upper end of the second base plate 108b. The fourth and fifth working coils 106d, 106e may be spaced a predetermined distance apart at an upper end of the third base plate 108c.

The first, second, and third base plates 108a, 108b, 108c may be disposed such that the first, second, and third base plates 108a, 108b, 108c are adjacent to each other. The first, second, and third base plates 108a, 108b, 108c may be disposed at an upper end of the case 102.

The supporter 200 may be disposed in an inner space of the case 102. A plurality of supporters described above may be provided. Each of the plurality of supporters 200 may support a lower end of each of the first, second, and third base plates 108a, 108b, 108c.

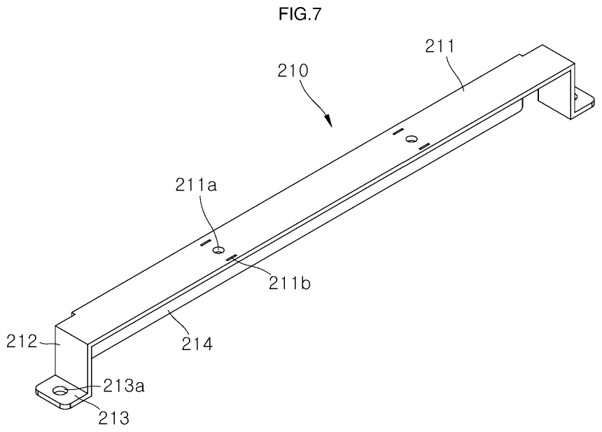

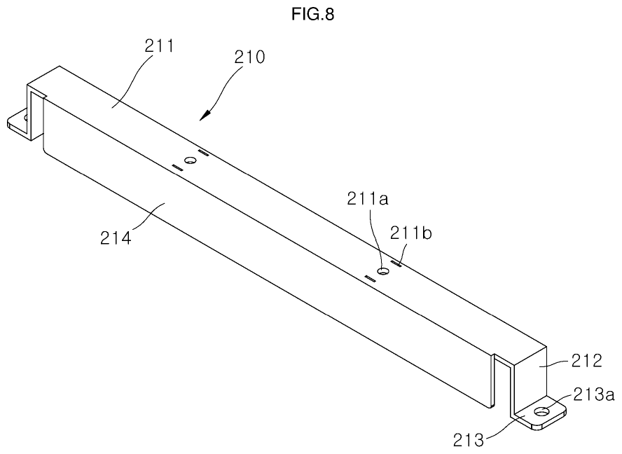

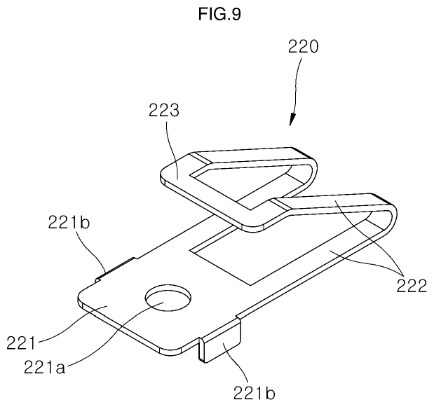

FIG. 7 is a perspective view of a bracket according to an embodiment. FIG. 8 is another perspective view of the bracket according to an embodiment. FIG. 9 is a perspective view showing an elastic member according to an embodiment.

A configuration of the supporter 200 according to an embodiment is described with reference to FIGS. 6 and 9.

The supporter 200 may include a bracket 210 and an elastic member 220. The bracket 210 may have a predetermined length and a predetermined width.

The bracket 210 may include a bracket body 211 and a pair of support bodies 212. The bracket body 211 may be formed to have a length which is less than an inner width of the case 102 by a predetermined length.

The first, second, and third base plates 108a, 108b, 108c may be disposed at an upper end of the case 102. Lower surfaces of the first, second, and third base plates 108a, 108b, 108c may have remaining exposure areas except for areas supported by the case 102.

A width of the exposure area may substantially correspond to a width supported by the supporter 200. Accordingly, a length of the bracket body 211 according to an embodiment may be the same as or less than the width of the exposure area by a predetermined width.

The pair of support bodies 212 may be bent in a downward direction at both ends of the bracket body 211. The pair of support bodies 212 may be bent such that the pair of support bodies 212 is orthogonal to the bracket body 211.

A fixing body 213 may bent to extend outwardly at lower ends respectively of the pair of support bodies 212. The fixing bodies 213 may be bent such that the fixing body 213 is orthogonal to the support body 212. Further, each fixing body 213 may be fixed onto the bottom surface 102b of the inner space of the above case 102. The bottom surface of the case may also a protrusion protruding upwardly to be engaged or inserted with the coupling holw to thereby fix the position of the bracket.

Each of the fixing bodies 213 may have a plate shape, for example. A width of each fixing body 213 may be the same as a width of the support body 212 and the bracket body 211. Alternatively, the width of each fixing body 213 may be greater than the width of the support body 212 and the bracket body 211 to increase a surface area supported.

Each of the fixing bodies 213 may have a coupling hole 213a. The case 102 may have another coupling hole (not illustrated) on a bottom surface 102b of the case which contacts each fixing body 213. A coupling member (not illustrated) may couple the coupling hole 213a and the coupling hole described above. Accordingly, each fixing body 213 may be fixed onto the bottom surface 102b of the inner space of the case 102.

A plurality of elastic members 220 described above may be disposed at an upper end of the bracket body 211. The plurality of elastic members 220 may be disposed at a plurality of positions of the upper end of the bracket body 211.

Lower ends of the plurality of elastic members 220 may be fixed to the upper end of the bracket body 211. Upper ends of the plurality of elastic members 220 may elastically support the lower surface of each of the first, second, and third base plates 108a, 108b, 108c.

The plurality of elastic members 220 may have the same configuration. Each elastic member 220 may be a leaf spring having a V shape, for example. The elastic member 220 may include a fixed piece 221, an elastic piece 222, and a support piece 223.

The fixed piece 221 may be fixed to a predetermined position of the upper end of the bracket body 211. The fixed piece 221 may have a fixing hole 221a. The fixed piece 221 may have a pair of position determination projections 221b, bent in the downward direction, at both side portions thereof. The position determination projection 221b may have a rectangle shape.

A fixing hole 211a may be formed at a predetermined position of the bracket body 211. The fixing hole 211a described above may have a pair of position determination holes 211b, at both side portions thereof. The position determination hole 211b may be formed into a hole having a rectangle shape. A fixing member (not illustrated) may be coupled to the fixing hole 221a and the fixing hole 211a described above. Accordingly, the fixed piece 221 may be fixed to the upper end of the bracket body 211. Further, the pair of position determination projections 221b may be fitted into the pair of position determination holes 211b.

The support piece 223 may be disposed above the fixed piece 221. The fixed piece 221 may support the lower surfaces of the first, second, and third base plates 108a, 108b, 108c disposed on the bracket body 211.

The elastic piece 222 may have a predetermined level of elastic force. The elastic piece 222 may elastically connect the fixed piece 221 and the support piece 223. A lower end of the elastic piece 222 may connect to one (first) end of the fixed piece 221, and the other end may connect to one (first) end of the support piece 223. The elastic piece 222 may have a V shape that spreads apart in one direction/toward one side.

The elastic piece 222 may be formed into a body branched into two at the one end of the fixed piece 221. The support piece 223 may connect to an upper end of the elastic piece 222, branched into two, in a plate form.

Accordingly, the lower surface of each of the first, second, and third base plates 108a, 108b, 108c may be supported by the support piece 223, and the fixed piece 221 may be fixed to the upper end of the bracket body 211. Additionally, the elastic piece 222 may elastically support the lower surface of each of the first, second, and third base plates 108a, 108b, 108c, between the fixed piece 221 and the support piece 223.

A reinforcing body 214 may be formed in one side portion of the bracket body 211. The reinforcing body 214 may be integrated with the bracket body 211.

The reinforcing body 214 may be bent at one side of the bracket body 211 in the downward direction. The reinforcing body 214 may be bent such that the reinforcing body 214 is orthogonal to the bracket body 211. Alternatively, a bending angle of the reinforcing body 214 is not limited to the angle at which the reinforcing body 214 is orthogonal to the bracket body 211. A single reinforcing body 214 described above may be disposed at one lateral surface portion of the bracket body 211 or a plurality of reinforcing bodies 214 described above may be provided. The reinforcing bodies 214 may be spaced a predetermined distance apart in the surface portion at the one side of the bracket body 211.

A predetermined gap may be formed between a lower end of the reinforcing body and the bottom surface 102b of the case, or the lower end of the reinforcing body may be fixed or contact onto the bottom surface of the case.

The reinforcing body 214 may help to increase rigidity of the bracket body 211 and may prevent bending or deformation of the bracket body 211 itself having a predetermined length.

Though not illustrated in the drawings, the reinforcing body 214 according to an embodiment may be symmetrically formed in surface portions of the one (first) side and the other (second) side of the bracket body 211.

The reinforcing body 214 according to an embodiment may also protrude from a center of a lower end of the bracket body 211 downward. The reinforcing body 214 according to an embodiment may also be formed into a protruding grid shape, at the lower end of the bracket body 211.

The bracket 210 according to an embodiment may be fixed onto the bottom surface of the inner space of the case 102. Additionally, the elastic members 220 disposed at an upper end of the bracket 210 may support the lower surfaces of the base plate 108a, 108b, 108c. In this case, fixation of the position of the bracket 210 may be an important factor.

Though not illustrated in the drawings, a pair of mounting grooves may be further formed on the bottom surface of the case 102 according to an embodiment. The pair of mounting grooves may have a predetermined depth from the bottom surface of the case 102.

The pair of fixing bodies 213 described above may be inserted into and mounted onto the pair of mounting grooves. The pair of mounting grooves may have a shape corresponding to a shape of the fixing bodies 213. As each fixing body 213 is fitted into and fixed to each mounting groove at both ends of the bracket body 211, deformation of the bracket 210 itself may be prevented. The fixing body 213 mounted onto the mounting groove may be fixed through an additional fixing member such as a bolt.

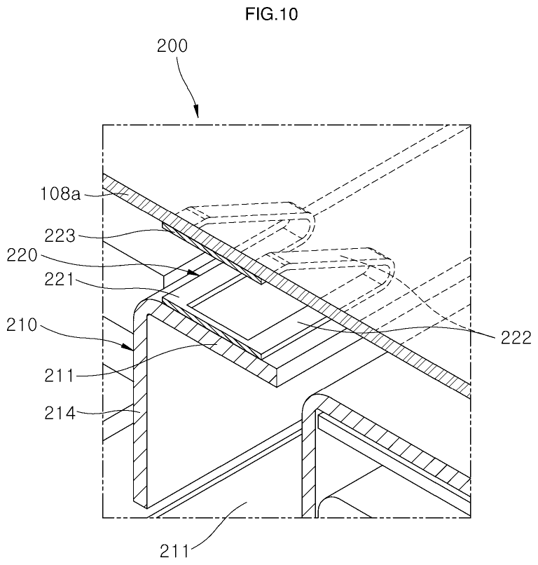

FIG. 10 is a perspective view of a supporter according to an embodiment elastically supporting a lower portion of a base plate. Referring to FIGS. 6 and 10, a plurality of supporters 200 according to an embodiment may respectively provide elastic support to the lower surface of each of the first, second, and third base plates 108a, 108b, 108c. The first base plate 108a is described as an example.

Both ends of the bracket body 211 having a predetermined length may be fixed onto the bottom surface 102b of the inner space of the case 102 by each support body 212 and each fixing body 213. The bracket body 211 may be spaced a predetermined distance apart from the bottom surface 102b depending on a height of the support body 212.

The bracket body 211 may have a predetermined length and may be disposed below the first base plate 108a along a widthwise direction of the first base plate 108a. The elastic members 220 disposed at a plurality of positions of the upper end of the bracket body 211 may elastically support a plurality of positions of the lower surface of the first base plate 108a. Each of the elastic members 220 according to an embodiment may be formed into a leaf spring. Accordingly, when the elastic members 220 elastically support a plurality of positions of the lower surface of the first base plate 108a, a predetermined distance of elastic flow may be formed by the elastic members 220 along an up-down or vertical direction. With the above configuration, the supporter 200 according to an embodiment may support a plurality of positions of the lower surface of the first base plate 108a along the widthwise direction of the first base plate 108a.

When the first working coil 106a is disposed at the upper end of the first base plate 108a, the supporter 200 according to an embodiment may prevent downward bending of a central portion of the first base plate 108a, caused due to the weight of the first working coil 106a. Further, the supporter 200 according to an embodiment may be provided with the elastic member 220. Accordingly, when an external impact is applied to the first base plate 108a, the supporter 200 may absorb an impulsive force caused by the external impact.

Positions supported by the elastic members 200 according to an embodiment may correspond to positions of the first base plate 108a under the area in which the first working coil 106a is disposed. Accordingly, the elastic members 200 according to an embodiment may stably support the first working coil 106a. Alternatively, positions of the elastic members 200 supporting the lower surfaces of the second and third base plates 108b, 108c may also correspond to positions under the area in which the corresponding working coils are disposed.

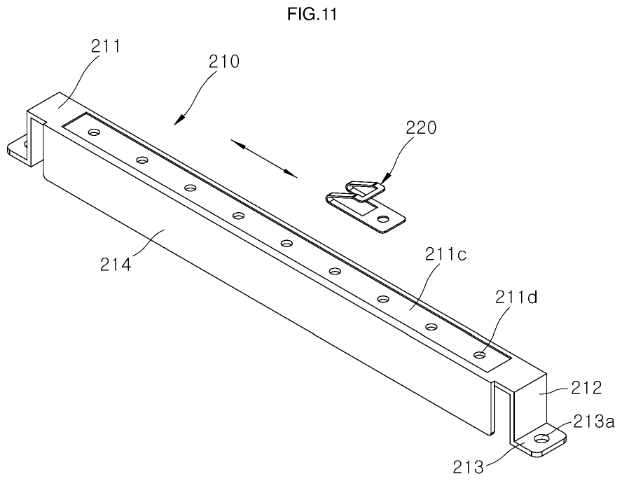

FIG. 11 is view showing an example in which a position of an elastic member according to an embodiment may be changed at an upper end of a bracket. Referring to FIG. 11, a guide groove 211c may be formed at the upper end of the bracket body 211 according to an embodiment.

The fixed piece 221 of each elastic member 220 according to an embodiment may be coupled to the guide groove 211c in a rail form. Fixing hole 221a may be formed at the fixed piece 221. The above position determination projection 221b may be removed from the fixed piece 221.

A plurality of other fixing holes 211d may be spaced a predetermined distance apart from each other in the guide groove 211c.

The elastic member 220 may move along the guide groove 211c linearly. A position of the elastic member 220 may change. When the fixing hole 221a of the fixed piece 221 is aligned with any one of the other fixing holes 211d at a position to which the elastic member 220 moves, the fixing hole 211a and any one of the other fixing holes 211d may be fixed through a fixing member (not illustrated).

Accordingly, the elastic member 220 may make a linear movement on the bracket body 211 and may be fixed to the position to which the elastic member 220 moves. With this configuration, a support position on a lower surface of a corresponding base plate may change depending on a size of a working coil, according to embodiments.

Though not illustrated in the drawings, at least one elastic element (not illustrated) may be disposed on/over the air guide 120a, 120b, 120c. The elastic element may be a leaf spring. Alternatively, the elastic element may also be an elastic member, such as rubber or sponge, in addition to a leaf spring.

An upper end of the at least one elastic element described above may contact the lower surface of the base plate 108a, 108b, 108c and prevent bending of the base plate 108a, 108b, 108c.

A guide groove that guides movement of at least one elastic element described above may be further formed at an upper end of the air guide. Accordingly, the at least one elastic element described above may move to a predetermined position. As a result, a position of the lower surface of the base plate, elastically supported by the elastic element, may change. Additionally, a position supported by the elastic element may be a position included in a surface area of a working coil disposed at the upper end of the base plate, for example.

According to embodiments disclosed herein, a lower portion of a base plate on which a working coil is disposed may be supported to a predetermined length, thereby preventing sagging of the base plate, as described above with reference to the examples. A constant gap between an object to be heated and a working coil may be maintained, thereby preventing heat generation of the working coil as well as ensuring uniformity in heating of the object to be heated.

According to embodiments disclosed herein, an elastic member may elastically support a lower portion of a base plate on which a working coil is disposed, thereby absorbing an external impact applied to the base plate. Further, a bracket itself, which supports a lower portion of a base plate, may be reinforced, thereby preventing deformation of the bracket.

Embodiments disclosed herein are directed to an electric range in which a lower portion of a base plate, on which a working coil is disposed, may be supported to a predetermined length, thereby preventing sagging of the base plate. Embodiments disclosed herein are also directed to an electric range in which an elastic member may elastically support a lower portion of a base plate, on which a working coil is disposed, thereby absorbing an external impact applied to the base plate. Embodiments disclosed herein are further directed to an electric range in which a bracket itself, which supports a lower portion of a base plate, may be reinforced, thereby preventing deformation of the bracket.

Aspects are not limited to the above ones, and other advantages that are not mentioned above may be clearly understood from the following description and can be more clearly understood from the embodiments set forth herein. Additionally, the advantages may be realized via means and combinations thereof that are described in the appended claims.

In the electric range according to embodiments disclosed herein, a lower end of the base plate, which allows a working coil to be placed at an upper end thereof, may be supported by a supporter along a widthwise direction of the base plate, thereby preventing a bend of the base plate and maintaining a constant gap between an object to be heated and the working coil. The supporter may be formed into a bracket having a predetermined length and may stably support a lower end of a base plate. Elastic members may be disposed between the bracket and the base plate and may elastically support a plurality of positions of a lower end of a base plate. Further, the electric range may be provided with a reinforcing body bent at the bracket to prevent deformation of the bracket itself.

According to embodiments disclosed herein, a lower portion of a base plate on which a working coil is disposed may be supported to a predetermined length, thereby preventing sagging of the base plate. Further, according to embodiments disclosed herein, a constant gap between an object to be heated and a working coil may be maintained, thereby preventing heat generation of the working coil as well as ensuring uniformity in heating of the object to be heated.

Furthermore, according to embodiments disclosed herein, an elastic member may elastically support a lower portion of a base plate on which a working coil is disposed, thereby absorbing an external impact applied to the base plate. Also, a bracket itself, which supports a lower portion of a base plate, may be reinforced, thereby preventing deformation of the bracket.

The embodiments are described above with reference to a number of illustrative embodiments thereof. However, embodiments are not intended to limit the embodiments and drawings set forth herein, and numerous other modifications and embodiments may be devised by one skilled in the art without departing from the technical spirit. Further, the effects and predictable effects based on the configurations are to be included within the range of the disclosure though not explicitly described in the description of the embodiments.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electric range, comprising:
a case an upper portion of which is open and which has an inner space;
at least one base plate disposed at the upper portion of the case;
at least one working coil disposed on the at least one base plate; and
at least one supporter disposed on a bottom surface of the case, and an upper surface of which supports a lower surface of the at least one base plate along a widthwise direction of the case.

2. The electric range of claim 1, wherein the at least one supporter is provided with a bracket both ends of which are supported by the bottom surface of the case, and a plurality of elastic members disposed at a plurality of positions on an upper surface of the bracket and configured to elastically support the lower surface of the at least one base plate.

3. The electric range of claim 2, wherein the bracket has a linear shape.

4. The electric range of claim 2, wherein the bracket comprises a bracket body having a predetermined length and width and having a linear shape, and a pair of support bodies bent at both ends of the bracket body, wherein the plurality of elastic members is disposed at an upper surface of the bracket body, and wherein the pair of support bodies is fixed onto the bottom surface of the case.

5. The electric range of claim 4, wherein a plate having a coupling hole is respectively formed at a lower end of each of the pair of support bodies, and each plate is fixed to the bottom surface of the case by a coupling member coupled to the coupling hole and the bottom surface of the case.

6. The electric range of claim 4, wherein the bracket body has a reinforcing body having a plate shape and bent in a downward direction.

7. The electric range of claim 6, wherein the reinforcing body is formed at a first side, a second side, or both sides of the bracket body.

8. The electric range of claim 6, wherein a lower end of the reinforcing body is spaced a predetermined distance apart from the bottom surface of the case.

9. The electric range of claim 2, wherein each of the plurality of elastic members is a leaf spring that spreads apart in a V shape.

10. The electric range of claim 2, wherein a position of each of the plurality of elastic members is configured to be changed along a guide groove formed on the upper surface of the bracket.

11. The electric range of claim 1, wherein the at least one supporter comprises a plurality of supporters that support different positions of the lower surface of the at least one base plate.

12. The electric range of claim 1, wherein the at least one base plate comprises a plurality of base plates disposed at the upper end of the case such that the plurality of base plates is positioned adjacent to each other, and wherein the at least one supporter comprises a plurality of supporters configured to support a lower surface of each of the plurality of base plates.

13. The electric range of claim 1, wherein at least one air guide is disposed in the inner space of the case, and wherein an upper surface of the at least one air guide supports the lower surface of the at least one base plate.

14. The electric range of claim 1, wherein the at least one working coil is disposed at a central portion of the at least one base plate, and wherein the at least one supporter is configured to support of the lower surface at the central portion of the at least one base plate.

15. The electric range of claim 14, wherein the at least one supporter is configured to support an area under the central portion of the at least one working coil, at the lower surface of the at least one base plate.

16. An electric range, comprising:
a case an upper portion of which is open and which has an inner space;
at least one base plate disposed at the upper portion of the case;
at least one working coil disposed on the at least one base plate; and
at least one supporter disposed on a bottom surface of the case, and an upper surface of which supports a lower surface of the at least one base plate along a widthwise direction of the case, wherein the at least one supporter is provided with a bracket both ends of which are supported by the bottom surface of the case, and a plurality of elastic members disposed at a plurality of positions of an upper surface of the bracket and configured to elastically support the lower surface of the at least one base plate, wherein the bracket comprises a bracket body having a predetermined length and width and having a linear shape, and a pair of support bodies bent at both ends of the bracket body, wherein the plurality of elastic members is disposed at an upper surface of the bracket body, wherein the pair of support bodies is fixed onto the bottom surface of the case, wherein the bracket body has a reinforcing body having a plate shape and bent in a downward direction, and wherein each of the plurality of elastic members is formed into a leaf spring having a V shape.

17. An electric range, comprising:
a case an upper portion of which is open and which has an inner space;
at least one base plate disposed at the upper portion of the case;
at least one working coil disposed on the at least one base plate; and
at least one supporter disposed on a bottom surface of the case, and an upper surface of which supports a lower surface of the at least one base plate, wherein the at least one supporter comprises a linear-shaped bracket that extends along a widthwise direction of the case, both ends of which are supported by the bottom surface of the case, and a plurality of elastic members disposed at a plurality of positions on an upper surface of the bracket and configured to elastically support the lower surface of the at least one base plate.

18. The electric range of claim 17, wherein the bracket comprises a bracket body having a predetermined length and width and having a linear shape, and a pair of support bodies bent at both ends of the bracket body, wherein the plurality of elastic members is disposed at an upper surface of the bracket body, and wherein the pair of support bodies is fixed onto the bottom surface of the case.

19. The electric range of claim 18, wherein the bracket body has a reinforcing body having a plate shape and bent in a downward direction, and wherein the reinforcing body is formed at a first side, a second side, or both sides of the bracket body.

20. The electric range of claim 17, wherein the at least one base plate comprises a plurality of base plates disposed at the upper end of the case such that the plurality of base plates is positioned adjacent to each other, and wherein the at least one supporter comprises a plurality of supporters configured to support a lower surface of each of the plurality of base plates.
